(19) United States
(12) Patent Application Publication
(10) Pub. No.: US 2019/0211912 A1
(43) Pub. Date: Jul. 11, 2019

(54) Axial Driven Overrunning Alteration Pulleys

(71) Applicant: ALT AMERICA INC., Westland, MI (US)

(72) Inventors: Wenhuan Wang, Westland, MI (US); Hao Xu, Jiangsu Province (CN)

(21) Appl. No.: 15/865,489

(22) Filed: Jan. 9, 2018

(51) Int. Cl. F16H 55/36; F16D 3/12; F16D 41/20

(52) U.S. Cl. CPC F16H 55/36; F16D 41/206; F16D 3/12

(57) ABSTRACT

An overrunning alternator pulley includes: a shaft including a flange disposed at a first end of the shaft, an axle extending from a first side of the flange to a second end of the shaft, the second end of the shaft being opposed to the first end of the shaft, first splines including one or more teeth, the one or more teeth being disposed on the axle proximate to the flange, a pulley including an inner bore extending through the pulley, and a bearing adapted to engage the first splines, in which the bearing transmits torque when a relative rotation between the pulley and the shaft is in a first direction, and the bearing overruns when the relative rotation between the pulley and the shaft is in a second direction opposite to the first direction.

### TECHNICAL FIELD

This disclosure relates to an axial-driven overrunning alternator pulley.

### BACKGROUND

Traditional vehicle engines produce a large amount of emissions. To reduce the emissions, engines can be designed to be smaller in size. In order to maintain the same level of engine power output as traditional engines, the load on components, such as an alternator-pulley system, can increase significantly for a downsized engine. This can lead to belt slip, undesirable vibration, and noise, which may increase wear of the alternator and/or other components and may decrease a useful lifetime of an alternator-pulley system of the engine. Further, other sources of vibration within an engine may add to the vibration caused by the pulley, which may cause the pulley and/or alternator rotor associated with the alternator to run irregularly. This irregular running of the alternator rotor significantly reduces the efficiency of the pulley-alternator system of the engine.

### SUMMARY

Disclosed herein are implementations of axial-driven overrunning alternator pulleys.

In an aspect, an overrunning alternator pulley associated with a vehicle engine is disclosed. The overrunning alternator pulley comprises: a shaft comprising a flange disposed at a first end of the shaft, an axle extending from a first side of the flange to a second end of the shaft, the second end of the shaft being opposed to the first end of the shaft, first splines comprising one or more teeth, the one or more teeth being disposed on the axle proximate to the flange, a pulley comprising an inner bore extending through the pulley, and a bearing adapted to engage the first splines, wherein the bearing transmits torque when a relative rotation between the pulley and the shaft is in a first direction, and the bearing overruns when the relative rotation between the pulley and the shaft is in a second direction opposite to the first direction.

In another aspect, a pulley is disclosed. The pulley comprises: a shaft comprising a flange disposed at a first end of the shaft, an axle extending from a first side of the flange to a second end of the shaft, the second end of the shaft being opposed to the first end of the shaft, and a bearing, comprising an inner bore extending through the bearing, an upper portion adapted to engage a portion of the shaft, a middle portion comprising a roller, wherein the roller is adapted to engage a portion of the upper portion, and a lower portion comprising a chamber adapted to receive a portion of the roller, wherein the middle portion is arranged between the upper portion and the lower portion.

In another aspect, a system for reducing vibration and noise associated with a vehicle engine is disclosed. The system comprises: a shaft comprising a flange disposed at a first end of the shaft, an axle extending from a first side of the flange to a second end of the shaft, the second end of the shaft being opposed to the first end of the shaft, a first key set comprising one or more teeth disposed on the axle proximate to the flange, and a bearing, comprising an inner bore extending through the bearing, an upper portion comprising a second key set comprising one or more teeth disposed on the inner bore of the bearing, wherein the second key set is adapted to mate with the first key set, a middle portion comprising a roller, wherein the roller is adapted to engage a portion of the upper portion, and a lower portion comprising a chamber, wherein the chamber is adapted to receive a portion of the roller, wherein the middle portion is arranged between the upper portion and the lower portion, a washer comprising an inner bore adapted to receive a portion of the flange of the shaft, a pulley, comprising an inner bore extending through the pulley, wherein the inner bore of the pulley is adapted to receive the washer and a portion of the bearing, and a ball bearing comprising an inner bore that receives a portion of the axle, wherein the ball bearing is adapted to be received by the inner bore of the pulley.

Variations in these and other aspects, features, elements, implementations, and embodiments of the methods, apparatus, procedures, and algorithms disclosed herein are described in further detail hereinafter.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 illustrates an example axial-driven overrunning alternator pulley according to the principles of the present disclosure.

FIG. 2 illustrates a shaft according to the principles of the present disclosure.

FIG. 3 illustrates a bearing according to the principles of the present disclosure.

FIGS. 4A-4B illustrate a pulley including a washer according to the principles of the present disclosure.

FIG. 5 illustrates another bearing according to the principles of the present disclosure.

FIG. 6 illustrates an exploded view of an axial-driven overrunning alternator pulley of FIG. 1 according to the principles of the present disclosure.

### DETAILED DESCRIPTION

A vehicle typically utilizes electrical power in order to control ignition components and/or other electronic components associated with the vehicle. A vehicle engine, such as a spark-ignition internal combustion engine or other suitable engines, includes an alternator-pulley system. As the vehicle engine operates, the vehicle engine drives a belt associated with the alternator-pulley system which drives an alternator of the alternator-pulley system. The alternator charges a battery of the vehicle, which may be used to supply the electrical power required to control ignition components on vehicle startup. The engine and/or components of the alternator-pulley system may produce undesirable vibration and/or noise while the engine and the alternator-pulley system operate. As the amount of electrical power utilized by a modern vehicle has increased, alternator loads and engine torsional fluctuations have increased proportionally. Accordingly, it may be desirable to utilize an alternator-pulley system that includes higher decoupling capabilities than typical alternator-pulley systems, which may reduce vibration and/or noise generated by the alternator-pulley system. This may prolong the life of the alternator-pulley system and/or the vehicle engine while increasing an efficiency of power transmission from the engine to the alternator.

In some embodiments, according to the principles of the present disclosure, an alternator-pulley system includes an axial-driven overrunning alternator pulley. An axial-driven overrunning alternator pulley is adapted to transmit torque from the engine to the alternator axial-driven upon acceleration of the engine. The axial-driven overrunning alternator pulley is adapted to decouple the alternator and the pulley when the alternator overruns the pulley. The axial-driven overrunning alternator pulley reduces engine vibration and/or noise. Additionally, or alternatively, the axial-driven overrunning alternator pulley can reduce belt jitter, increase power transmission efficiency of the battery charging system, and prolong the useful life of components within the alternator-pulley system and/or other components associated with the engine.

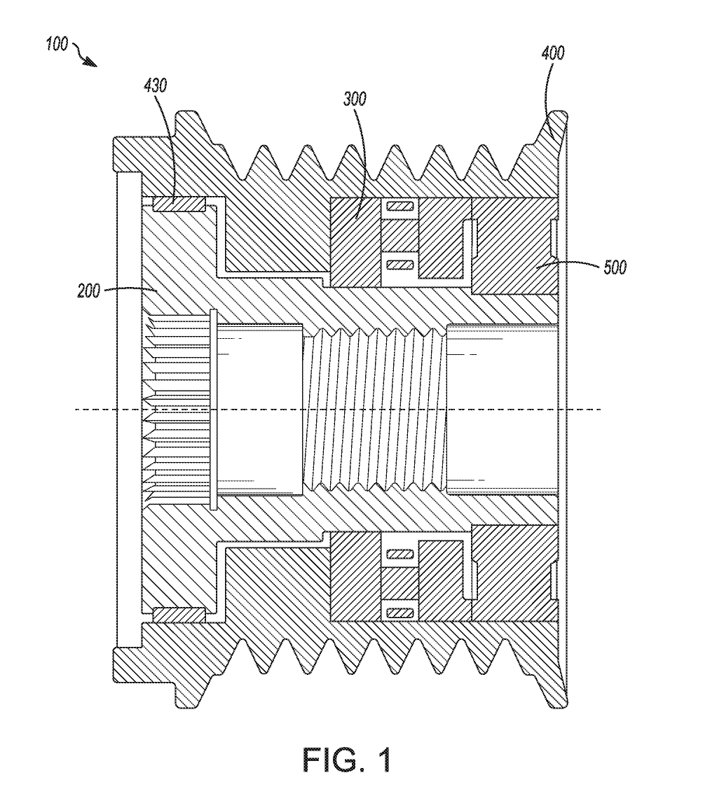

FIG. 1 generally illustrates an example axial-driven overrunning alternator pulley 100 according to the principles of the present disclosure. The axial-driven overrunning alternator pulley 100 can be associated with a vehicle engine, such as a spark-ignition internal combustion engine, as described above. The axial-driven overrunning alternator pulley 100 transmits torque from the engine to the alternator when the engine speed increases, and decouples the engine and the alternator when the engine speed is decreased. Additionally, or alternatively, the axial-driven overrunning alternator pulley 100 may reduce, inhibit, and/or eliminate vibration and noise associated with an alternator-pulley system and/or other components of the vehicle engine.

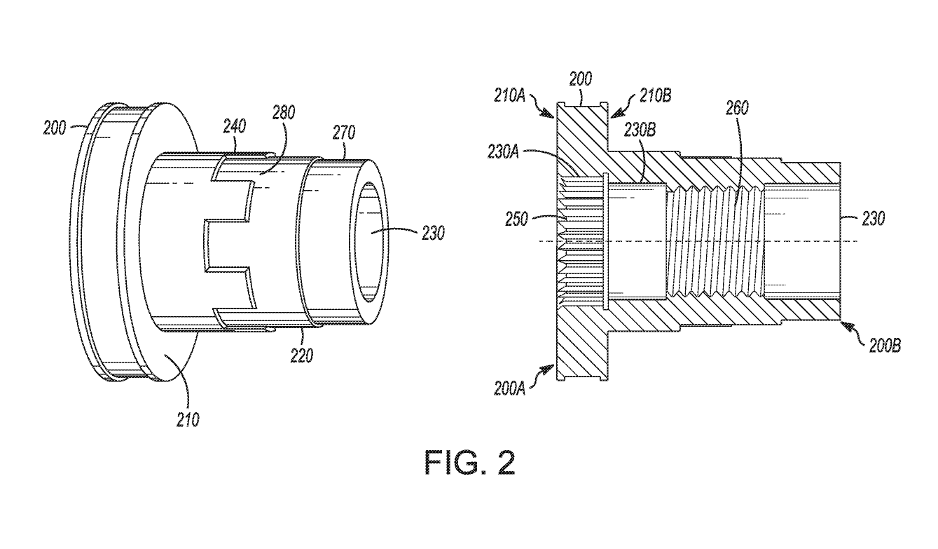

The axial-driven overrunning alternator pulley 100 includes a shaft 200, as is generally illustrated in FIG. 2. The shaft includes a flange 210, an axle 220, an inner bore 230, and splines 240. The splines 240 can include one or more teeth or keys. It should be noted that the splines 240 can be implemented in various ways, such as a non-spline key set. The flange 210 is disposed at a first end 200A of the shaft 200. The axle 220 extends from a first side 210A of the flange 210 to a second end 200B of the shaft 200. The first end 200A of the shaft 200 is disposed on an opposite side of the shaft 200 from the second end 200B of the shaft 200. The inner bore 230 extends through a central or substantially central portion of the shaft 200 from the first end 200A of the shaft 200 to the second end 200B of the shaft 200. The inner bore 230 includes a first inner portion 230A and a second inner portion 230B. The first inner portion 230A and the second inner portion 230B both include a surface that has a generally cylindrical profile. The generally cylindrical profile of the first inner portion 230A has a diameter that is larger than a diameter associated with a generally cylindrical profile of the second inner portion 230B.

In some embodiments, the axle 220 includes a first outer portion 270, a second outer portion 280, and the splines 240. The first outer portion 270 and the second outer portion 280 both include a surface that has a generally cylindrical profile. A diameter associated with the generally cylindrical profile of the first outer portion 270 is smaller than a diameter associated with the generally cylindrical profile of the second outer portion 280. In some embodiments, the splines 240 includes one or more teeth (or keys and key seats) that are disposed on the second outer portion 280 of the axle 220. For example, the splines 240 includes a profile which may be a substantially square profile, a substantially round profile or any suitable profile, and the profile of the splines 240 may be formed by cutting out a portion of the second outer portion 280. In some embodiments, the one or more teeth of the splines 240 are evenly distributed around the outer profile of the axle 220.

The shaft 200 includes splines 250 disposed on the surface of the first inner portion 230A. The splines 250 can be straight-sided splines, involute splines, other suitable splines, or a combination thereof. The shaft 200 includes helical threads 260 disposed on the surface of the second inner portion 230B. The helical threads 260 can be left-handed threads, right-handed threads, or other suitable threads. In some embodiments, the shaft 200 may be adapted to cooperate with a portion of an alternator to transmit torque to the alternator by engaging the helical threads 260 and splines 250 to a portion of an alternator shaft. For example, the alternator shaft may include helical threads that are adapted to mate or cooperate with the helical threads 260. For example, the helical threads associated with the alternator shaft may have the same or similar pitch, hand, and nominal diameter as the helical threads 260. The alternator shaft can be mated with (e.g., screwed into) the inner bore 230 to engage the shaft 200. The alternator shaft can also have splines that match the splines 250 of the shaft 200. The alternator shaft engages the shaft 200 by mating the splines of the alternator shaft with the splines 250 of the shaft 200. The tightness of the engagement of the alternator shaft and the shaft 200 can be adjusted by a special wrench or another suitable device. As described, the diameter of the first inner portion 230A is larger than the diameter associated with the second inner portion 230B, such that the alternator shaft cannot pass into or through the inner bore 230.

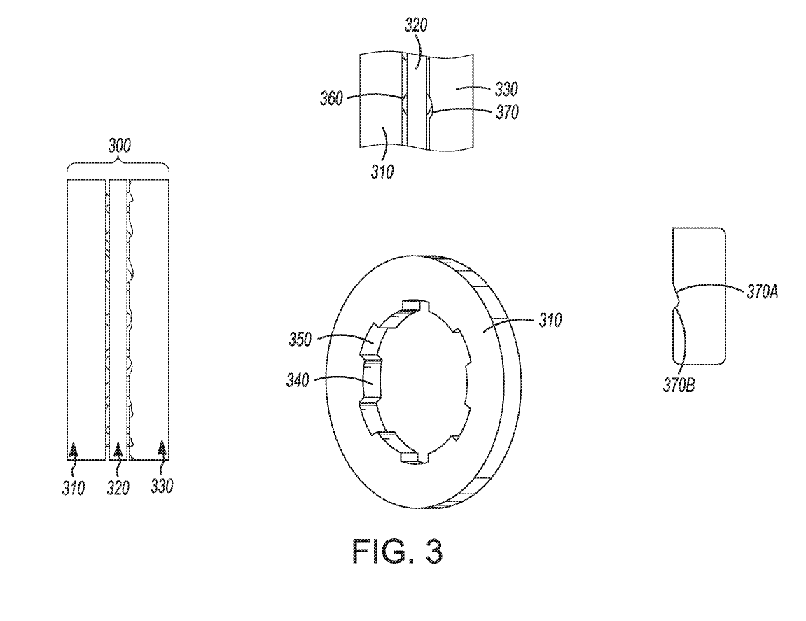

The axial-driven overrunning alternator pulley 100 includes a bearing 300, as is generally illustrated in FIG. 3. The bearing 300 includes an upper portion 310, a middle portion 320, and a lower portion 330, and an inner bore 340 extends from the upper portion 310 to the lower portion 330. The middle portion 320 includes one or more rollers 360. In some embodiments, the one or more rollers 360 can be placed on both sides of the middle portion 320. In some embodiments, the lower portion 330 includes a chamber 370 disposed on a first side of the lower portion 330 between the middle portion 320 and the lower portion 330. The one or more rollers 360 is adapted to engage a first side of the upper portion 310 between the middle portion 320 and the upper portion 310. The chamber 370 is adapted to receive a portion of the rollers 360. For example, the one or more rollers 360 can be cylinders or balls.

In some embodiments, the chamber 370 includes an asymmetric wedge-shaped profile. The asymmetric wedge-shaped profile includes two surfaces that are defined by a lower ramp 370B and an upper ramp 370A separately. The slope of the profile of the lower ramp 370B is steeper than the slope of the profile of the upper ramp 370A. For example, the slope of the upper ramp 370A and the lower ramp 370B may be designed, such that the roller 360 rides up the upper ramp 370A and locks/jams the upper portion 310 and the lower portion 330 when the roller 360 is driven by the chamber 370 in a first direction, but does not ride up the lower ramp 370B or roll between the upper portion 310 and the lower portion 330 when the roller 360 is driven by the chamber 370 in a second direction relatively opposite to the first direction.

In some embodiments, the upper portion 310 includes a splines 350 that form the inner profile of the upper portion 310. The splines 350 is adapted to receive the splines 240. The splines 350 can include one or more teeth or keys. It should be noted that the splines 350 can be implemented in various ways to receive the splines 240, such as a non-spline key set. For example, the splines 350 may include one or more teeth (or keys and key seats) that are mating with the one or more teeth of the splines 240 and are defined by the profile of the splines 240. In some embodiments, the one or more teeth of the splines 350 is evenly distributed around the inner profile of the inner bore 340, and the splines 350 is adapted to slide fit into the splines 240.

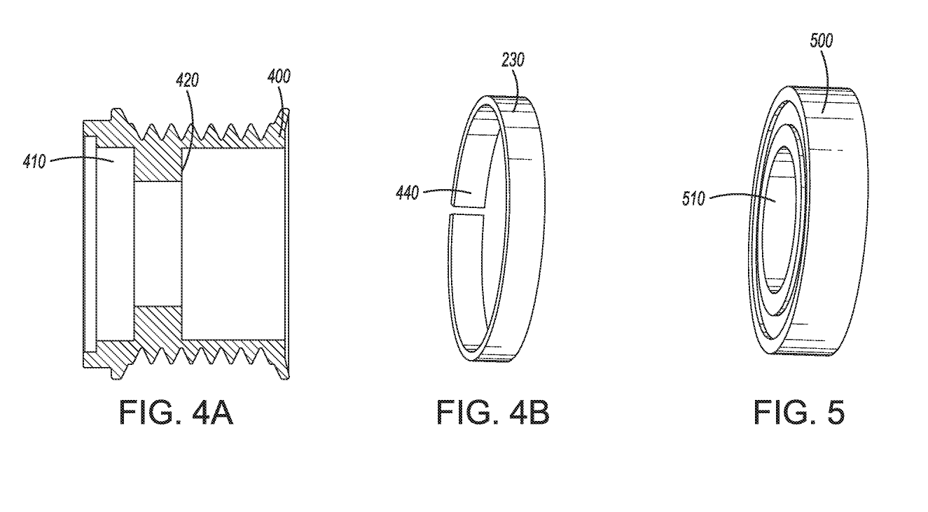

In some embodiments, the axial-driven overrunning alternator pulley 100 includes a pulley 400, as is generally illustrated in FIGS. 4A-4B. The pulley 400 includes an inner bore 410 and a stopper 420. The stopper 420 includes a profile adapted to prevent the bearing 300 from passing through the inner bore 410. In some embodiments, a first side of the stopper 420 is adapted to engage a portion of the upper portion 310 of the bearing 300. For example, the stopper 420 includes a profile having a diameter that is smaller than a diameter associated with the inner bore 410 and the diameter associated with the outer profile of the upper portion 310, such that the upper portion 310 cannot pass through the inner bore 410.

In some embodiments, the pulley 400 includes a washer 430. The outer profile of the washer 430 is defined by the inner profile of the inner bore 410, and the washer 430 is adapted to be received by the inner bore 410. For example, the washer 430 is press fit into the inner bore 410, and the washer 430 can be adapted to slide on the inner bore 410. In some embodiments, the washer 430 includes an inner bore 440 that is adapted to receive a portion of the flange 210. For example, the flange 210 is press fit into the inner bore 440, and the washer 430 can be adapted to rotate about the flange 210.

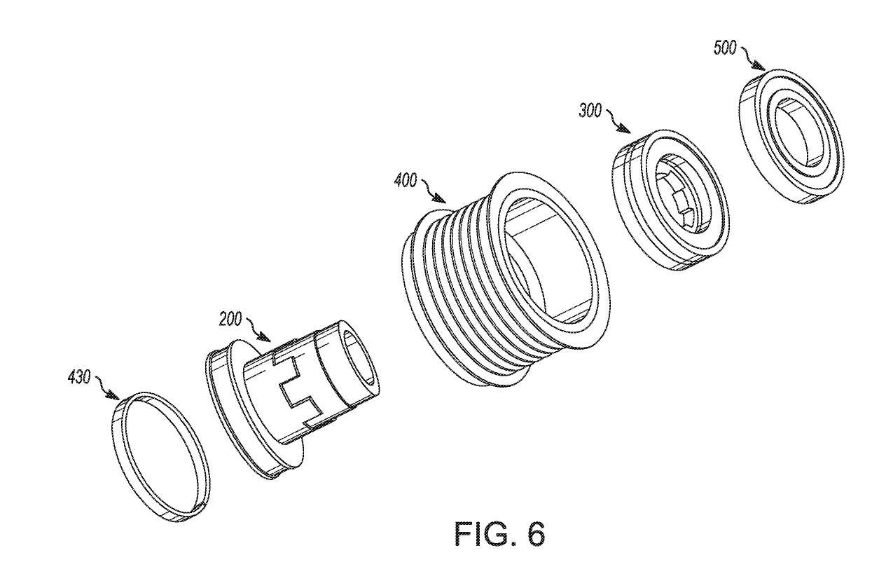

The axial-driven overrunning alternator pulley 100 includes a bearing 500, as is generally illustrated in FIG. 5. In some embodiments, the bearing 500 can be a ball bearing or other suitable bearings. The bearing 500 includes an inner bore 510 that is adapted to receive a portion of the axle 220. In some embodiments, the bearing 500 is disposed at a second side of the lower portion 330 of the bearing 300, opposite to the first side, and is adapted to rotate about the axle 220. For example, the inner profile of the inner bore 510 is adapted to correspond with the first outer portion 270 of the axle 220, and the bearing 500 is press fit into the axle 220. In some embodiments, the bearing 500 can be adapted to be received by the inner bore 410 of the pulley 400. For example, the bearing 500 can be press fit into the inner bore 410 of the pulley 400.

FIG. 6 generally illustrates an exploded view of the axial-driven overrunning alternator pulley 100 that includes the washer 430, the shaft 200, the pulley 400, the bearing 300, and the bearing 500. As described above, the pulley 400 is adapted to receive the shaft 200 and the bearing 300. In some embodiments, as described above, the washer 430 is adapted to receive the round edge of the flange 210 and is adapted to be received by the inner bore 410 of the pulley 400.

In some embodiments, the axle 220 of the shaft 200 is inserted through the inner bore 340 of the bearing 300. As described above, the second outer portion 280 of the axle 220 is adapted to engage the upper portion 310 of the bearing 300, such that the splines 240 of the shaft 200 fits snug within the splines 350 of the upper portion 310 of the bearing 300. The surface of the first outer portion 270 includes a diameter that is smaller than the diameter associated with the inner bore 340 of the bearing 300, such that the bearing 300 only engages the axle 220 by the upper portion 310. The bearing 300 is adapted to rotate about the axle 220 of the shaft 200.

In some embodiments, the round edge profile of the lower portion 330 includes a diameter that is larger than a diameter associated with the round edge profile of the middle portion 320 and a diameter associated with the round edge profile of the upper portion 310, and the round edge profile of the lower portion 330 is adapted to correspond with the inner surface of the inner bore 410. For example, the lower portion 330 is press fit into the inner bore 410, and the upper portion 310 can rotate within the inner bore 410 when the upper portion 310 is not engaged with the lower portion 330.

In some embodiments, the bearing 300 is adapted to transmit torque from the pulley 400 to the shaft 200 when the pulley 400 runs faster than the shaft 200 and will decouple the pulley 400 and the shaft 200 when the shaft 200, overruns the pulley 400. For example, the upper portion 310 of the bearing 300 can engage the shaft 200 and the lower portion 330 of the bearing 300 can engage the inner bore 410 of the pulley 400. When the load on the pulley 400 increases, the pulley 400 accelerates in a first direction. The lower portion 330 of the bearing 300 accelerates with the pulley 400 in a first direction. When the linear velocity of the lower portion 330 exceeds the linear velocity of the upper portion 310, the roller 360 rides up the upper ramp 370A and locks/jams the upper portion 310 and the lower portion 330. The upper portion 310 and the lower portion 330 are engaged, and the bearing 300 transmits torque from the pulley 400 to the shaft 200.

When the load on the pulley 400 decreases, the pulley 400 decelerates in the first direction. The lower portion 330 of the bearing 300 decelerates with the pulley 400 in the first direction. When the linear velocity of the lower portion 330 falls below the linear velocity of the upper portion 310, the roller 360 rolls on the lower ramp 370B, and the lower portion 330 slides upon the upper portion 310. The bearing 300 decouples the upper portion 310 and the lower portion 330 and allows the shaft 200 to overrun the pulley 400.

In some embodiments, an overrunning alternator pulley for reducing vibration and noise associated with a vehicle engine may include: a shaft that includes a flange disposed at a first end of the shaft; an axle extending from a first side of the flange to a second end of the shaft, the second end of the shaft being opposed to the first end of the shaft; a first key set that includes one or more teeth (or one or more first keys and first key seats) being disposed on the axle of the shaft proximate the flange of the shaft; a pulley that includes an inner bore extending through the pulley; and a bearing being adapted to engage the first key set of the shaft that transmits torque in response to a relative rotation of the pulley, and the shaft is in a first direction and overruns in response to a relative rotation of the pulley, and the shaft is in a second direction opposite to the first direction. The first key set can include one or more keys. In some embodiments, the first key set can include splines. It should be noted that the first key set can be implemented in various ways, including but not limited to splines.

In some embodiments, a pulley may include: a shaft that includes a flange disposed at a first end of the shaft; an axle extending from a first side of the flange to a second end of the shaft, the second end of the shaft being opposed to the first end of the shaft; and a bearing that includes: an inner bore extending through the bearing; an upper portion of the bearing being adapted to engage a portion of the shaft; a middle portion of the bearing that includes a roller, wherein the roller is adapted to engage a portion of the upper portion of the bearing; and a lower portion of the bearing that includes a chamber being adapted to receive a portion of the cylindrical roller of the middle portion.

In some embodiments, a system for reducing vibration and noise associated with a vehicle engine may include: a shaft that includes a flange disposed at a first end of the shaft; an axle extending from a first side of the flange to a second end of the shaft, the second end of the shaft being opposed to the first end of the shaft; a first key set that includes one or more teeth (or one or more first keys and first key seats) being disposed on the axle of the shaft proximate the flange of the shaft; and a bearing that includes: an inner bore extending through the bearing; an upper portion of the bearing including a second key set that includes one or more teeth (or one or more second keys and second key seats) being disposed on the inner bore of the bearing, wherein the second key set is adapted to mate with the first key set being disposed on the axle of the shaft; a middle portion of the bearing that includes a cylindrical roller wherein the roller is adapted to engage a portion of the upper portion of the bearing; and a lower portion of the bearing that includes a chamber being adapted to receive a portion of the roller of the middle portion; a washer that includes an inner bore that receives a portion of the flange of the shaft; a pulley that includes an inner bore extending through the pulley that is adapted to receive the washer and a portion of the bearing; and a ball bearing that includes an inner bore that receives a portion of the axle of the shaft, wherein the ball bearing is adapted to be received by the inner bore of the pulley. The first and second key sets can include one or more keys. In some embodiments, the first and second key sets can include first and second splines, respectively. It should be noted that the first and second key sets can be implemented in various ways, including but not limited to splines.

As used herein, the term “or” is intended to mean an inclusive “or” rather than an exclusive “or”. That is, unless specified otherwise, or clear from context, “X includes A or B” is intended to indicate any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

While the disclosure has been described in connection with certain embodiments or implementations, it is to be understood that the disclosure is not to be limited to the disclosed embodiments or implementations but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. An overrunning alternator pulley associated with a vehicle engine, comprising:
a shaft comprising a flange disposed at a first end of the shaft;
an axle extending from a first side of the flange to a second end of the shaft, the second end of the shaft being opposed to the first end of the shaft;
first splines comprising one or more teeth, the one or more teeth being disposed on the axle proximate to the flange;
a pulley comprising an inner bore extending through the pulley; and
a bearing adapted to engage the first splines, wherein the bearing transmits torque when a relative rotation between the pulley and the shaft is in a first direction, and the bearing overruns when the relative rotation between the pulley and the shaft is in a second direction opposite to the first direction.

2. The overrunning alternator pulley of claim 1, wherein the bearing further comprises:
an inner bore extending through the bearing;
an upper portion having second splines comprising one or more teeth disposed on the inner bore of the upper portion of the bearing, wherein the second splines is adapted to mate with the first splines;
a middle portion comprising a roller, wherein the roller is adapted to engage a portion of the upper portion; and
a lower portion comprising a chamber adapted to receive a portion of the roller, wherein the middle portion is arranged between the upper portion and the lower portion.

3. The overrunning alternator pulley of claim 2, wherein the chamber of the lower portion of the bearing further comprises an asymmetric wedge-shaped profile, wherein the roller jams the lower portion and the upper portion when a relative rotation of the lower portion and the upper portion is in the first direction, and the roller rolls between the lower portion and the upper portion when the relative rotation of the lower portion and the middle portion is in the second direction.

4. The overrunning alternator pulley of claim 1, further comprising a washer having an inner bore that receives a portion of the flange of the shaft.

5. The overrunning alternator pulley of claim 4, wherein the inner bore of the pulley is adapted to receive the washer and the bearing.

6. The overrunning alternator pulley of claim 5, wherein the inner bore of the pulley comprises a stopper adapted to engage a portion of the upper portion of the bearing, wherein the stopper stops the bearing from passing through the inner bore of the pulley.

7. The overrunning alternator pulley of claim 5, further comprising a ball bearing including an inner bore extending through the ball bearing that receives a portion of the axle of the shaft, wherein the ball bearing is adapted to be received by the inner bore of the pulley.

8. The overrunning alternator pulley of claim 1, wherein the shaft comprises an inner bore extending from the first end to the second end of the shaft, the inner bore having splines disposed proximate the first end of the shaft.

9. The overrunning alternator pulley of claim 8, wherein the inner bore of the shaft comprises helical threads disposed around an inner portion of the shaft proximate the second end of the shaft.

10. A pulley, comprising:
a shaft comprising a flange disposed at a first end of the shaft;
an axle extending from a first side of the flange to a second end of the shaft, the second end of the shaft being opposed to the first end of the shaft; and
a bearing, comprising:
an inner bore extending through the bearing;
an upper portion adapted to engage a portion of the shaft;
a middle portion comprising a roller, wherein the roller is adapted to engage a portion of the upper portion; and
a lower portion comprising a chamber adapted to receive a portion of the roller, wherein the middle portion is arranged between the upper portion and the lower portion.

11. The pulley of claim 10, wherein the shaft further comprises a first key set comprising one or more teeth disposed on the axle proximate to the flange, and the upper portion of the bearing further comprises a second key set comprising one or more teeth disposed on the inner bore of the upper portion, wherein the second key set is adapted to mate with the first key set.

12. The pulley of claim 11, wherein the first key set comprises first splines, and the second key set comprises second splines.

13. The pulley of claim 10, wherein the chamber of the lower portion further comprises an asymmetric wedge-shaped profile, wherein the roller jams the lower portion and the upper portion of the bearing when a relative rotation of the lower portion and the upper portion is in a first direction, and the roller rolls between the lower portion and the upper portion when the relative rotation of the lower portion and the upper portion is in a second direction opposite to the first direction.

14. The pulley of claim 10, further comprising a washer having an inner bore adapted to receive a portion of the flange of the shaft.

15. The pulley of claim 14, further comprising an inner bore extending through the pulley, wherein the inner bore is adapted to receive the washer and the bearing.

16. The pulley of claim 15, wherein the inner bore of the pulley further comprises a stopper adapted to engage a portion of the upper portion of the bearing, wherein the stopper stops the bearing from passing through the inner bore of the pulley.

17. A system for reducing vibration and noise associated with a vehicle engine, comprising:
a shaft comprising a flange disposed at a first end of the shaft;
an axle extending from a first side of the flange to a second end of the shaft, the second end of the shaft being opposed to the first end of the shaft;
a first key set comprising one or more teeth disposed on the axle proximate to the flange; and
a bearing, comprising:
an inner bore extending through the bearing;
an upper portion comprising a second key set comprising one or more teeth disposed on the inner bore of the bearing, wherein the second key set is adapted to mate with the first key set;
a middle portion comprising a roller, wherein the roller is adapted to engage a portion of the upper portion; and
a lower portion comprising a chamber, wherein the chamber is adapted to receive a portion of the roller, wherein the middle portion is arranged between the upper portion and the lower portion;
a washer comprising an inner bore adapted to receive a portion of the flange of the shaft;
a pulley, comprising an inner bore extending through the pulley, wherein the inner bore of the pulley is adapted to receive the washer and a portion of the bearing; and
a ball bearing comprising an inner bore that receives a portion of the axle, wherein the ball bearing is adapted to be received by the inner bore of the pulley.

18. The system of claim 17, wherein the shaft further comprises an inner bore extending from the first side to a second side, wherein the inner bore has splines disposed approximate the first side of the shaft and helical threads disposed approximate to the second end of the shaft.

19. The system of claim 17, wherein the inner bore of the pulley further comprises a stopper adapted to engage the upper portion of the bearing, wherein the stopper stops the bearing from passing through the inner bore of the pulley.

20. The system of claim 17, wherein the chamber of the lower portion of the bearing further comprises an asymmetric wedge-shaped profile, wherein the roller jams the lower portion and the upper portion when a relative rotation of the lower portion and the upper portion is in a first direction, and the roller rolls between the lower portion and the upper portion when the relative rotation of the lower portion and the upper portion is in a second direction opposite to the first direction.
